(19) United States
(12) Patent Application Publication
(10) Pub. No.: US 2017/0286915 A1
(43) Pub. Date: Oct. 5, 2017

(54) INFORMATION PROCESSING DEVICE, CONTROL METHOD, AND PROGRAM

(71) Applicant: SONY CORPORATION, TOKYO (JP)

(72) Inventors: YOSHIHIRO YAMAGUCHI, TOKYO (JP); TAKUYA FUJITA, KANAGAWA (JP)

(21) Appl. No.: 15/506,844

(22) PCT Filed: Jun. 16, 2015
(86) PCT No.: PCT/JP2015/067314

§ 371 Date: Feb. 27, 2017

(30) Foreign Application Priority Data
Sep. 16, 2014 (JP) 2014-187998

(51) Int. Cl. G06Q 10/10; H04W 68/04

(52) U.S. Cl. CPC G06Q 10/1093; H04W 68/04

(57) ABSTRACT

[Object] To provide an information processing device, a control method, and a program that can estimate a leisure time of a user, and provide information to the user at right timing. [Solution] The information processing device includes an estimation unit configured to extract an information input cycle within a predetermined period on the basis of a history of an information input operation performed by a user on an Internet, and to estimate a leisure time of the user, and a notification control unit configured to perform control to issue a predetermined notification during the estimated leisure time.

### TECHNICAL FIELD

The present disclosure relates to an information processing device, a control method, and a program.

### BACKGROUND ART

The recent developed communication technology has popularized mobile terminals such as smartphones and tablet terminals, allowing users to acquire information anytime anywhere. The internet, however, has a mass of information, and accordingly requires time and techniques to search for information. Information that users can actively acquire is then limited, and information that users can passively acquire in no time would be welcome.

When companies provide services to right users in right places at right time, the ultimate challenge for the competing companies is to know the users. For example, Patent Literature 1 discloses a user action predicting method for predicting a future action of a user on the basis of a history of a past action of the user. This allows service providers to provide a right service (such as a bidirectional television service) in accordance with the predicted user action.

Meanwhile, social network services (SNSs) have been rapidly gaining widespread use in recent years. Different from one-to-one communication such as telephones and e-mails, the SNS allows users to send information to a large number of specified or unspecified users at one time. Accordingly, users can send more casually send information that is not such important that someone specified has to be provided with the information, and the SNS is consequently used more frequently than telephones and e-mails. Users write messages into the SNS while the users have free times such as going to work and school, have break time, or are at home.

### CITATION LIST

### Patent Literature

Patent Literature 1: JP 2001-134706A

### SUMMARY OF INVENTION

### Technical Problem

When information is passively provided using mobile terminals such as smartphones and tablet terminals, service providers generally use the mobile terminals to notify users at timing at which information is provided from the service providers. Since the users carry the mobile terminals almost all the day long, the users are no sooner notified than the users can check the information.

The users are not, however, able to immediately check the provided information with the mobile terminals if the users are busy in other things such as working, having dinner with someone, and doing housework. As a result, it is not possible to adequately provide information. This notification interrupts the other things, and the users feel annoyed in fact in some cases.

The present disclosure then provides an information processing device, a control method, and a program that can estimate a leisure time of a user, and provide information to the user at right timing.

### Solution to Problem

According to the present disclosure, there is provided an information processing device including: an estimation unit configured to extract an information input cycle within a predetermined period on the basis of a history of an information input operation performed by a user on an Internet, and to estimate a leisure time of the user; and a notification control unit configured to perform control to issue a predetermined notification during the estimated leisure time.

According to the present disclosure, there is provided an control method including: extracting an information input cycle within a predetermined period on the basis of a history of an information input operation performed by a user on an Internet, and estimating a leisure time of the user; and performing control to issue a predetermined notification during the estimated leisure time.

According to the present disclosure, there is provided a program for causing a computer to function as an estimation unit configured to extract an information input cycle within a predetermined period on the basis of a history of an information input operation performed by a user on an Internet, and to estimate a leisure time of the user, and a notification control unit configured to perform control to issue a predetermined notification during the estimated leisure time.

### Advantageous Effects of Invention

According to the present disclosure as described above, it is possible to estimate a leisure time of a user, and to provide information to the user at right timing.

Note that the advantageous effects described above are not necessarily limited, but any advantageous effects that are shown in the present specification or any other advantageous effects that can be grasped from the present specification may be attained in combination of the above-described advantageous effects or instead thereof.

### BRIEF DESCRIPTION OF DRAWINGS

FIG. 1 is a diagram describing an overview of an information processing system according to an embodiment of the present disclosure.

FIG. 2 is a diagram describing notification control performed by the information processing system according to the present embodiment for a user.

FIG. 3 is a block diagram illustrating an example of a configuration of a server (information processing device) according the present embodiment.

FIG. 4 is a diagram describing leisure time estimation according to the present embodiment.

FIG. 5 is a diagram describing an example of a predetermined notification area of a display screen of a client.

FIG. 6 is a diagram describing feedback of a user operation on a notification issued during a leisure time according to the present embodiment.

FIG. 7 is a flowchart illustrating estimation processing on a leisure time according to the present embodiment.

FIG. 8 is a flowchart illustrating notification control processing according to a leisure time according to the present embodiment.

FIG. 9 is a diagram illustrating an example of a notification of friend application and a check screen according to the present embodiment.

FIG. 10 is a diagram illustrating an example of a notification for schedule check and a check screen according to the present embodiment.

FIG. 11 is a diagram illustrating an example of a notification of a questionnaire and a check screen according to the present embodiment.

FIG. 12 is a diagram illustrating an example of a notification of an advertisement and a check screen according to the present embodiment.

FIG. 13 is a diagram illustrating an example in which notifications are displayed in accordance with the present embodiment.

FIG. 14 is a flowchart illustrating notification control processing on a TODO list according to the present embodiment.

FIG. 15 is a diagram describing that a TODO list is registered.

FIG. 16 is a diagram illustrating an example of a notification of a TODO list and a check screen according to the present embodiment.

FIG. 17 is a flowchart illustrating status information presentation processing according to the present embodiment.

FIG. 18 is a diagram illustrating an example in which status information is displayed in accordance with the present embodiment.

FIG. 19 is a diagram illustrating another example in which status information is displayed in accordance with the present embodiment.

FIG. 20 is a diagram illustrating another example in which status information is displayed in accordance with the present embodiment.

FIG. 21 is a flowchart illustrating status information presentation processing according to the present embodiment.

FIG. 22 is a diagram illustrating an example in which status information is displayed in accordance with the present embodiment.

### DESCRIPTION OF EMBODIMENT(S)

Hereinafter, (a) preferred embodiment(s) of the present disclosure will be described in detail with reference to the appended drawings. In this specification and the drawings, elements that have substantially the same function and structure are denoted with the same reference signs, and repeated explanation is omitted.

The description will be made in the following order.

1. Overview of Information Processing System according to Embodiment of the Present Disclosure

### 2. Basic Configuration

### 3. Operation Processing

3-1. Estimation Processing on Leisure Time
3-2. Notification Control Processing according to Leisure Time
3-3. Status Presentation Processing Based on Leisure Time

### 4. Conclusion

### 1. OVERVIEW OF INFORMATION PROCESSING SYSTEM ACCORDING TO EMBODIMENT OF THE PRESENT DISCLOSURE

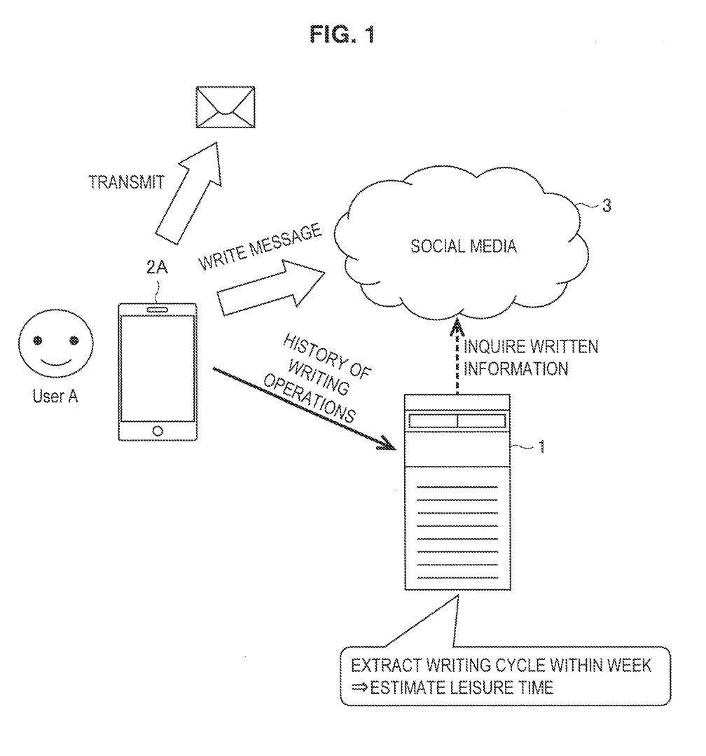

First of all, the overview of an information processing system according to an embodiment of the present disclosure will be illustrated in FIG. 1 and described. As illustrated in FIG. 1, the information processing system according to the present embodiment includes a client 2A that is a user terminal possessed by a user A, and a server 1 that is an information processing device which estimates a leisure time of the user A. Although FIG. 1 illustrates, as an example, a system in which the client 2A possessed by the user A is connected to the server 1, the information processing system according to the present disclosure is not limited thereto. The server 1 may be connected to clients (not illustrated).

For example, a smartphone is used as the client 2A. The user A can connect the client 2A to the Internet, write a message into a social media 3, and transmit an e-mail. The social media 3 includes, for example, a short message posting site, an article posting site, a social news site, and a social game, and it is possible to communicate with other users registered in the respective sites. The user A writes messages into the social media 3 and e-mails when the user A has a free time.

The server 1 acquires a writing log (history) of a user on the social media 3 and e-mails, regards a time during which the user is writing a message as a free time (during which any other things such as work, housework, and school are not prioritized), and estimates a leisure time of the user. More specifically, the server 1 can estimate that leisure times are available from 12:30 to 13:00 and from 19:00 to 21:00 on weekdays, and from 10:00 to 12:00 and from 16:00 to 18:00 on holidays, by extracting a predetermined period such as a writing cycle within a week.

As illustrated in FIG. 1, what is logged through protocol monitoring may be transmitted from the client 2A as a writing log of a user on the social media 3 and e-mails, or the server 1 may acquire the log by inquiring written information from the social media 3.

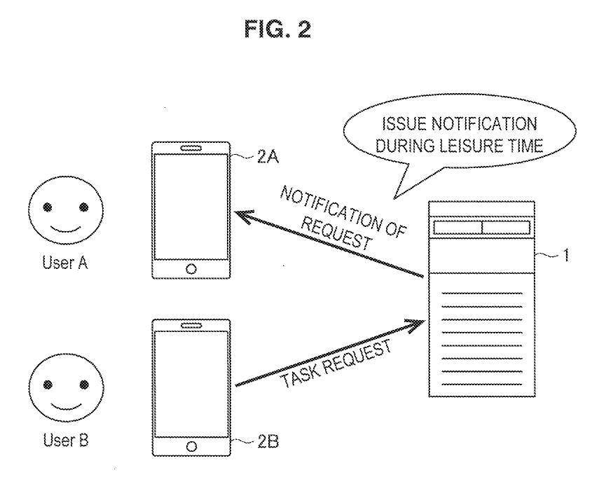

The information processing system according to the present embodiment can estimate a leisure time of a user in this way on the basis of the information written into the social media 3 and e-mails. The server 1 can then notify the user at right timing on the basis of the estimated leisure time. Notification control according to a leisure time will be described below with reference to FIG. 2.

FIG. 2 is a diagram describing notification control performed by the information processing system according to the present embodiment for a user. For example, when a client 2B that is an information processing device possessed by a user B is connected to the server 1, and the client 2B sends, via the server 1, the client 2A a task request (such as a message requesting a reply) to the user A from the user B as illustrated in FIG. 2, the server 1 controls the timing of notifying the client 2A of the task request transmitted from the client 2B.

Specifically, the server 1 notifies the client 2A if the user A is spending a leisure time at the time when the server 1 receives the task request from the client 2B. If the user A is not spending a leisure time, the server 1 performs control to accumulate the task request, and to issue a notification when a leisure time of the user A comes.

Notified during a leisure time, the user A is not disturbed when the user A is working on other things of higher priority. In addition, the user A is able to immediately check the content of the information. Accordingly, it is possible to adequately provide information to a user.

The server 1 may additionally present, to the user B, status information indicating whether or not the user A is spending a leisure time. In this case, before transmitting a task request, the user B can recognize whether or not the user A is able to immediately check the task request.

The overview of the information processing system according to an embodiment of the present disclosure has been described so far. Although the server 1 both estimates a leisure time and performs notification control based on the leisure time in the examples illustrated in FIGS. 1 and 2, the present embodiment is not limited thereto. Different information processing devices may estimate a leisure time and perform notification control based on the leisure time. The client 2 is not limited to the smartphones as illustrated in FIGS. 1 and 2, but may also include a tablet terminal, a mobile phone terminal, a personal digital assistant (PDA), a personal computer (PC), a portable music player, a portable game console, or a wearable terminal (such as a head mounted display (HMD), an eyeglass-type HMD, a watch-type terminal, and a band-type terminal). Next, the basic configuration of the server 1 included in the information processing system according to the present embodiment will be described.

### 2. BASIC CONFIGURATION

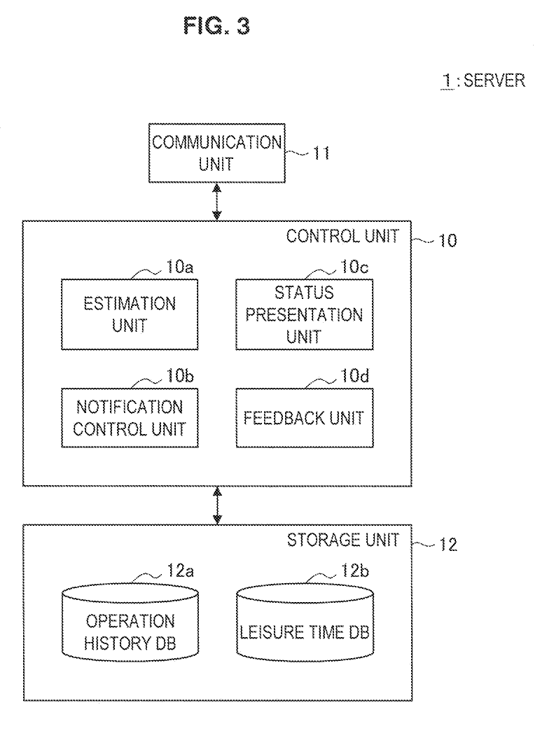

FIG. 3 is a block diagram illustrating an example of the configuration of the server 1 (information processing device) according the present embodiment. As illustrated in FIG. 3, the server 1 includes a control unit 10, a communication unit 11, and a storage unit 12.

### (Control Unit 10)

The control unit 10 includes a microcomputer including, for example, a central processing unit (CPU), read only memory (ROM), random access memory (RAM), non-volatile memory and an interface unit, and controls each unit of the server 1. Specifically, the control unit 10 according to the present embodiment functions as an estimation unit 10a, a notification control unit 10b, a status presentation unit 10c, and a feedback unit 10d as illustrated in FIG. 3.

Estimation Unit

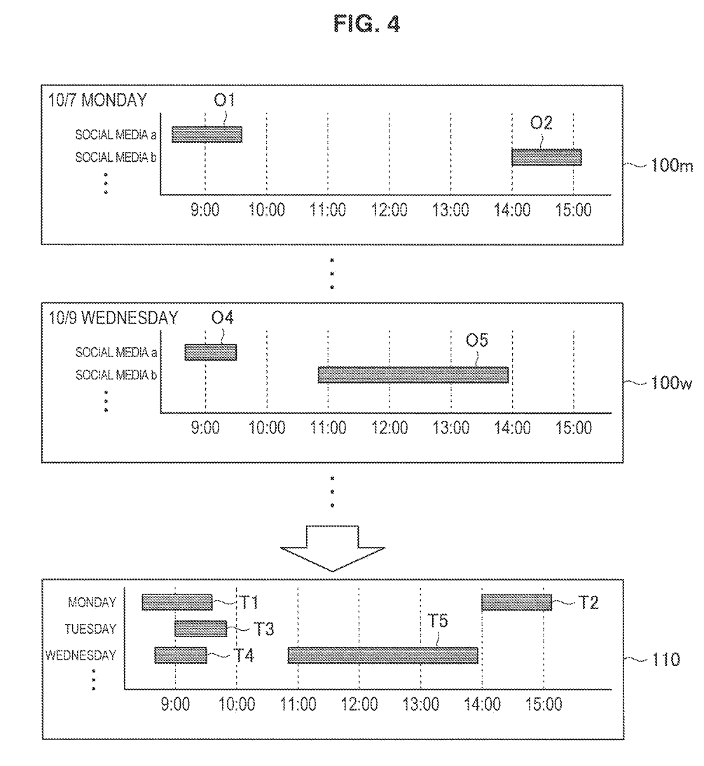

The estimation unit 10a extracts an information input cycle within a predetermined period on the basis of a history of information input operations performed by a user on the Internet, and estimates a leisure time of the user. More specifically, the estimation unit 10a extracts an input cycle within a week, for example, on the basis of a history of writing operations on the social media 3 and e-mails for the week, and estimates a time slot during which the writing operation is performed as a leisure time. The history of writing operations is acquired from the client 2 or the social media 3, and stored in an operation history DB 12a. Leisure time estimation according to the present embodiment will be described below with reference to FIG. 4.

FIG. 4 is a diagram describing leisure time estimation according to the present embodiment. As illustrated in FIG. 4, the estimation unit 10a refers to operation histories 100 for a week, for example, by referring to an operation history 100m of a user for Monday, . . . , an operation history 100w for Wednesday, . . . , and extracts operation time slots O1, O2, . . . , O4, and O5, during which information input operations are performed. The operation history 100m illustrated at the top of FIG. 4 indicates that a message is written into a social media a (operation time slot O1) around 9:00, and a message is written into a social media b from 14:00 to 15:00 (operation time slot O2). The estimation unit 10a extracts time slots for writing operations on all social media irrespective of the types of social media. Similarly, the estimation unit 10a also extracts time slots for writing operations on social media from the operation histories 100 for other days.

As illustrated at the bottom of FIG. 4, the estimation unit 10a then estimates leisure time data 110 of the user for the week. As illustrated in FIG. 4, the operation time slots O1 to O5 for writing messages into the social media and the like are regarded as leisure times T1 to T5 in the present embodiment. This estimation is based on the assumption that users write messages into the social media 3 and create and transmit e-mails with their client 2 when the users have free times, during which the users have nothing of higher priority.

The leisure time data estimated by the estimation unit 10a is stored in a leisure time DB 12b.

Although a leisure time is estimated using only a time for writing messages into social media and the like as an element in the example described with reference to FIG. 4, the leisure time estimation according to the present embodiment is not limited thereto. For example, after the estimation unit 10a extracts a cycle of time for writing messages into the social media and the like, the estimation unit 10a may generate a leisure time model in association with at least any of position information (latitude and longitude) on the client 2 at the writing time, another nearby user, and schedule registration for the time. This allows the estimation unit 10a to use the place in which the user is present, a person with whom the user is, or the registered schedule in addition to time in estimating a leisure time, as an element for estimating whether or not the user is spending a leisure time.

The estimation unit 10a may also estimate a leisure time on the basis of an analysis result of written content. More specifically, the estimation unit 10a analyzes the text of content written into the social media 3 and the like, and if the estimation unit 10a can determine that writing a message into the social media 3 and the like serves as part of work, the estimation unit 10a excludes the time for writing the content from the leisure times. Alternatively, the estimation unit 10a may determine on the basis of an address of an e-mail whether or not the user is working.

Notification Control Unit

The notification control unit 10b performs control to issue a predetermine notification to a user during a leisure time of the user estimated by the estimation unit 10a. More specifically, a notification of a task request is issued, the task request including a message from another user requesting a reply, an advertisement, a questionnaire, and a TODO list made by the user himself or herself. If the notification control unit 10b receives a message from another user requesting a reply or advertisement information while the user is not spending a leisure time, the notification control unit 10b temporarily accumulates the message or the advertisement information and collectively notifies the user of them when a leisure time of the user comes. A notification is issued (information is provided) during a leisure time of the user in this way, and the user can accordingly check the information once notified.

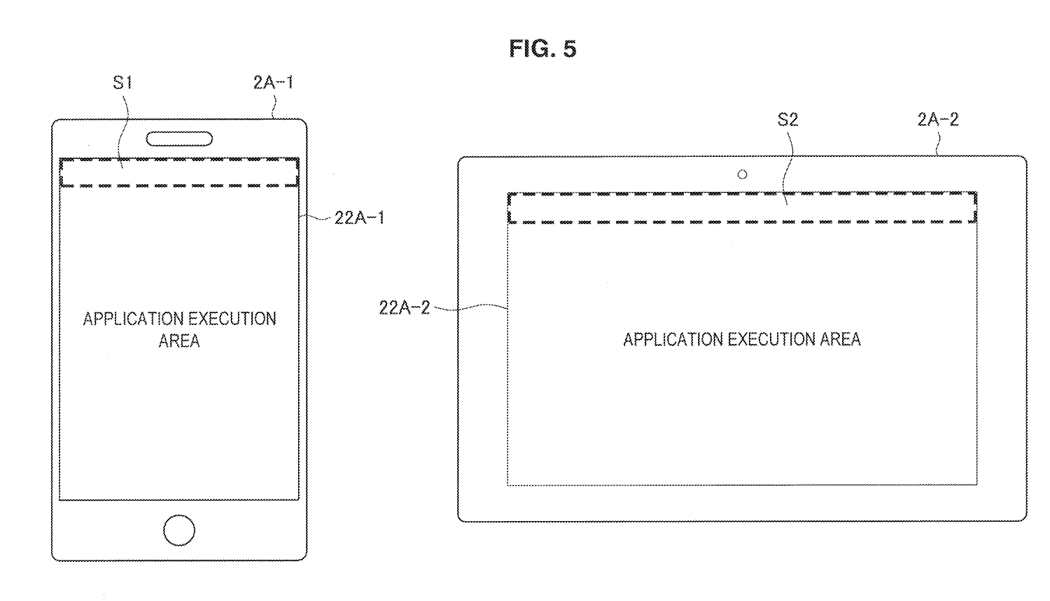

The notification control unit 10b performs control to display a notification on a predetermined notification area set at an end of a display screen of the client 2. An example of a notification area of the client 2 according to the present embodiment will be described here with reference to FIG. 5. As illustrated in the left part of FIG. 5, when a client 2A-1 implemented, for example, as a smartphone has the entire screen of a display unit 22A-1 used as an application execution area, the upper end of the display unit 22A-1 may be set as a notification area S1 and a notification may be displayed on the notification area S1. As illustrated in the right part of FIG. 5, when a client 2A-2 implemented, for example, as a tablet terminal has the entire screen of a display unit 22A-2 used as an application execution area, the upper end of the display unit 22A-2 may be set as a notification area S2 and a notification may be displayed on the notification area S2.

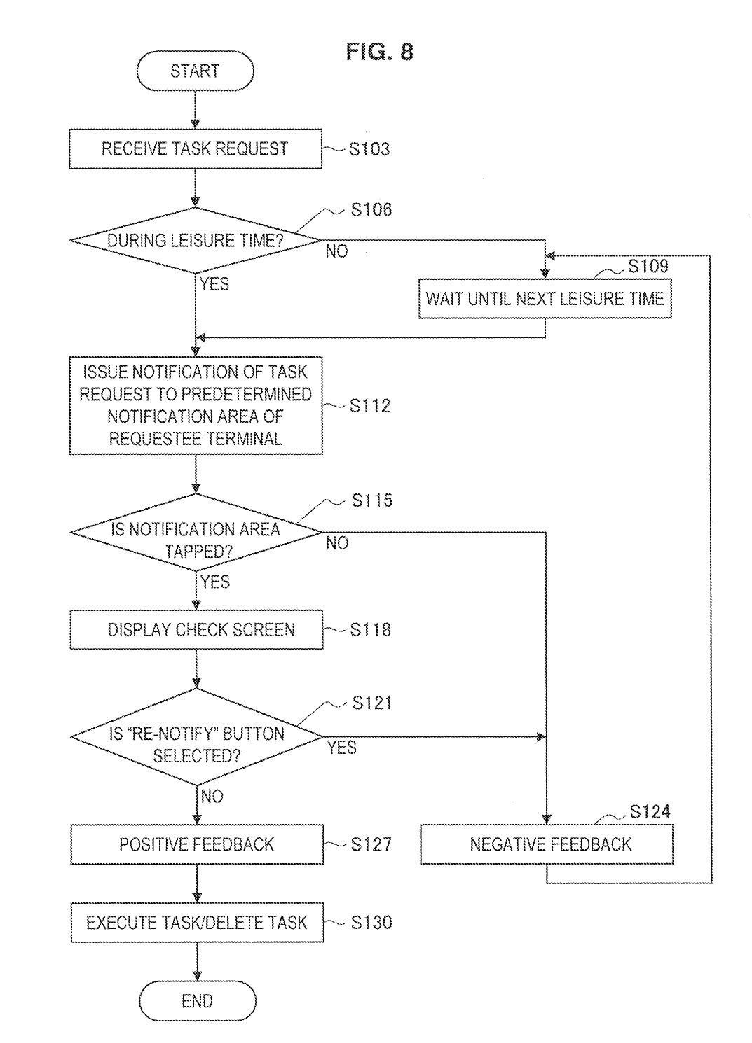

Once a user selects the notification displayed on the notification area (e.g. by tapping the notification area), the display unit 22 of the client 2 displays a check screen that displays the content of the notification and allows the user to select whether or not the use is able to respond to the notification. Such examples in which a notification and a check screen are displayed on the client 2 will be discussed below with reference to FIGS. 8 to 15.

Status Presentation Unit

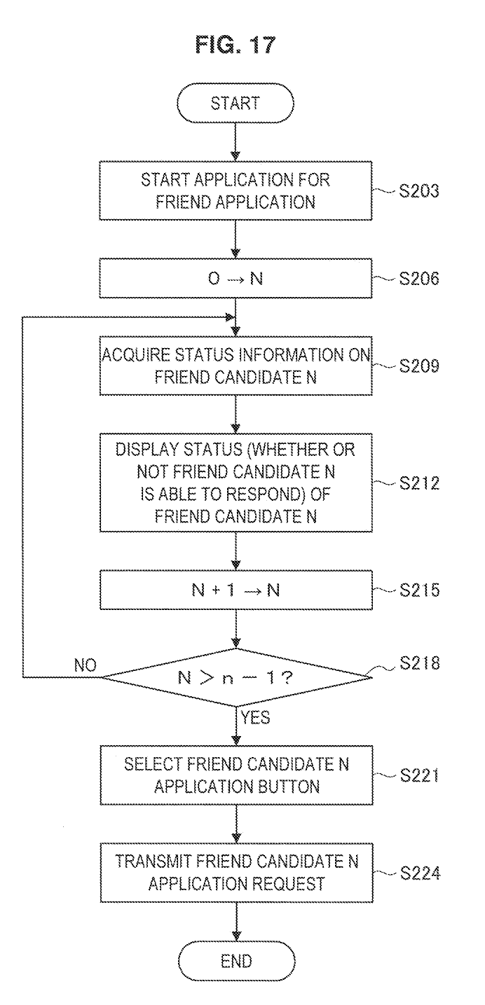

The status presentation unit 10c refers to the leisure time DB 12b, and presents, to a requester user, information indicating whether or not a target user is currently spending a leisure time. For example, when the user B starts a social media application in the client 2B, and the client 2B displays a screen for sending a message requesting a reply from a member and a screen for registering a new member, the client 2B inquires status information on a target user from the server 1. In response to the inquiry, the status presentation unit 10c of the server 1 replies, to the client 2B, with status information indicating whether or not the target user is currently spending a leisure time. Since it is indicated on the client 2B as the status information received from the server 1 whether or not the target user is currently spending a leisure time, the user B can recognize whether or not the target user is able to immediately check a message that has been sent to the target user and requests a reply. Such an example of a status information display screen of the client 2 for a target user will be discussed below with reference to FIGS. 17 to 19 and 21.

Feedback Unit

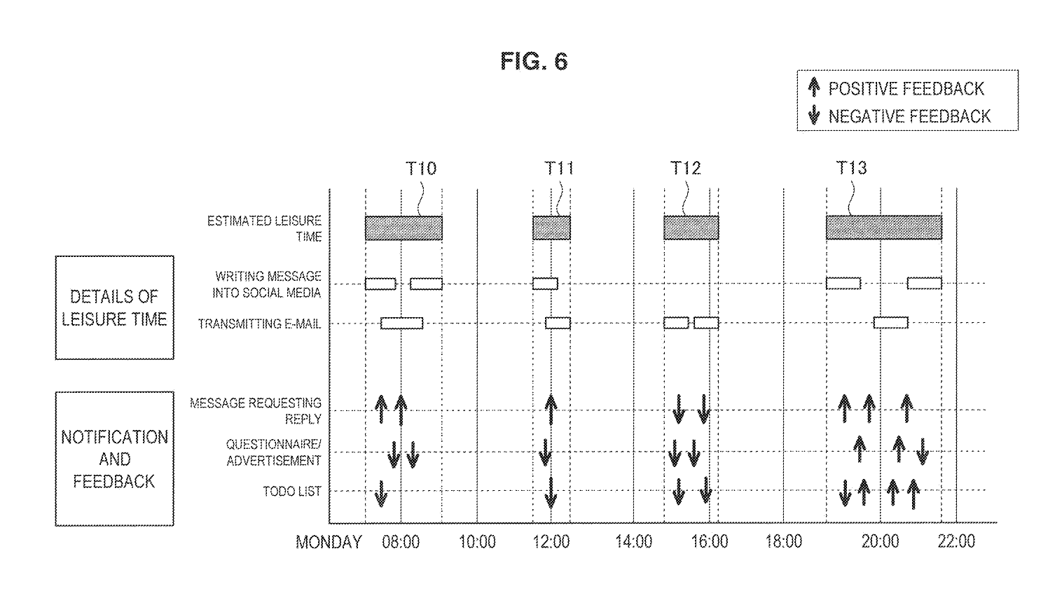

The feedback unit 10d acquires a user operation (feedback) on a notification issued to a user during a leisure time, and reflects the acquired user operation on the leisure time data of the user stored in the leisure time DB 12b. That is to say, a time for writing a message into a social media and the like is estimated as a leisure time in the present embodiment, but writing a message into a social media and the like exceptionally serves as part of work or writing a message into a social media and the like exceptionally has higher priority than checking the content of a notification in some cases. The leisure time data may be then adjusted for each user or each user attribute (such as age (generation), sex, and jobs) in accordance with a user operation (positive/negative feedback discussed below) on a notification issued during a leisure time in the present embodiment. It will be specifically described with reference to FIG. 6.

FIG. 6 is a diagram describing feedback of a user operation on a notification issued during a leisure time according to the present embodiment. As illustrated in FIG. 6, the estimation unit 10a estimates leisure times T10, T11, T12, and T13 on Monday on the basis of information input operations on the Internet such as writing messages into social media and transmitting e-mails.

The notification control unit 10b then issues a notification of a task request such as a message requesting a reply, a questionnaire, and a TODO list during the leisure time slots estimated by the estimation unit 10a. If the user substantially responds to the notification, the feedback unit 10d determines it as positive feedback. If the user does not substantially respond to the notification, the feedback unit 10d determines it as negative feedback. This allows the notification control unit 10b to learn what notification is easy to accept during which leisure time slot. The notification control unit 10b can then perform control to issue a predetermined notification during a leisure time slot during which the notification is easy to accept, on the basis of the leisure time data to which a user operation is fed back.

For example, positive/negative feedback of a user to a notification of a “message requesting a reply” shows that the notification is easy to accept during the leisure times T10, T11, and T13 while the notification is difficult to accept during the leisure time T12 in the example illustrated in FIG. 6. Positive/negative feedback of a user to a notification of a “questionnaire/advertisement” shows that the notification is difficult to accept during the leisure times T10, T11, and T12 while the notification is easy to accept during the leisure time T13. Positive/negative feedback of a user to a notification of a “TODO list” shows that the notification is difficult to accept during the leisure times T10, T11, and T12 while the notification is easy to accept during the leisure time T13.

In this case, the notification control unit 10b preferentially issues a notification of a “message requesting a reply” during the leisure times T10 and T11, but issues no notification during the leisure time T12. Although the notification of a “message requesting a reply” is easy to accept during the leisure time T13, this notification is also easy to accept during other leisure times (leisure times T10 and T11). Accordingly, notifications of a “questionnaire/advertisement” and a “TODO list” are preferentially issued during the leisure time T13.

The status presentation unit 10c can recommend a user who is about to transmit a “message requesting a reply” to do so during the leisure times T10 and T11 of a target user on the basis of the feedback illustrated in FIG. 6, and also recommend a service provider that is about to transmit a “questionnaire/advertisement” to do so during the leisure time T13 of a target user (or a target user attribute).

### (Communication Unit 11)

The communication unit 11 has a function of building a wireless/wired connection to an external device, and transmitting and receiving data. The communication unit 11 according to the present embodiment, for example, connects to the client 2, transmits a task request during a leisure time of a user under the control of the notification control unit 10b, and transmits status information on a target user to a requester user under the control of the status presentation unit 10c.

### (Storage Unit 12)

The storage unit 12 stores various kinds of data, and stores, for example, a program for executing various kinds of processing of the control unit 10. The storage unit 12 according to the present embodiment includes the operation history database (DB) 12a and the leisure time DB 12b.

For example, the operation history DB 12a stores an operation log of writing operations performed by a user on a social media, and operations performed by a user for making and transmitting e-mails. The operation log stored in the operation history DB 12a is used for the estimation unit 10a to estimate a leisure time. The leisure time DB 12b stores the leisure time data estimated by the estimation unit 10a. The leisure time data stored in the leisure time DB 12b is used for the notification control unit 10b to issue a notification of a task request, and for the status presentation unit 10c to present status information on a target user.

The specific structural elements of the server 1 according to the present embodiment have been described so far. Note that the server 1 does not have to include all the structural elements illustrated in FIG. 3, but can, for example, dispense with the feedback unit 10. Although the operation history DB 12a and the leisure time DB 12b are stored in the storage unit 12 serving as internal memory of the server 1 in the example illustrated in FIG. 3, the present embodiment is not limited thereto. The operation history DB 12a and the leisure time DB 12b may also be stored in external memory. A part or all of the structural elements of the server 1 illustrated in FIG. 3 may be provided in the client 2.

### 3. OPERATION PROCESSING

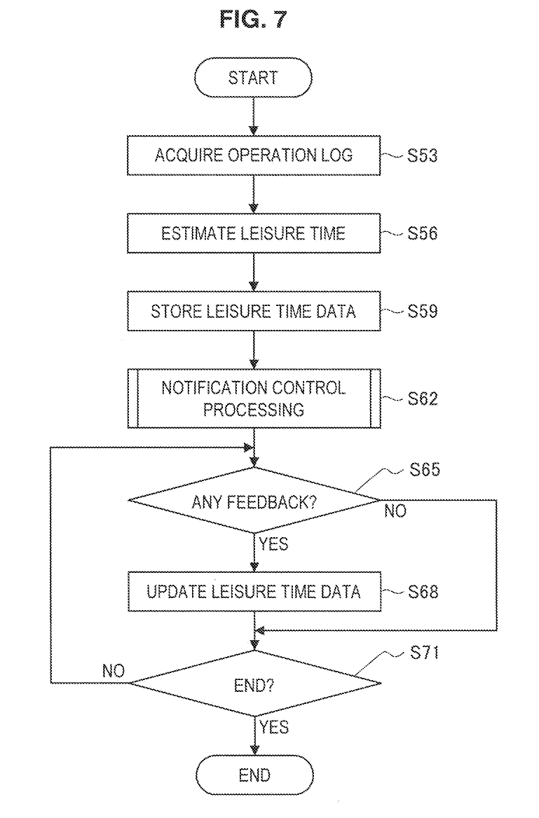

Next, operation processing of the information processing system according to the present embodiment will be specifically described with reference to FIGS. 7 to 22.

### <3-1. Estimation Processing on Leisure Time>

FIG. 7 is a flowchart illustrating estimation processing on a leisure time according to the present embodiment. First of all, the server 1 acquires an operation log of a user in step S53 as illustrated in FIG. 7. More specifically, the server 1 acquires a history of writing operations on a social media and the like. The acquired history of writing operations is stored in the operation history DB 12a.

Next, in step S56, the estimation unit 10a of the server 1 refers to the history of writing operations stored in the operation history DB 12a to estimate a leisure time of the user. More specifically, the estimation unit 10a extracts a writing cycle, for example, on the basis of a history of writing operations performed within a week, regards writing time slots as leisure times, and estimates the leisure times within the week. The estimated leisure time data is stored in the leisure time DB 12b (step S59).

In step S62, the notification control unit 10b performs notification control processing with reference to the leisure time data. The notification control processing will be discussed below with reference to FIG. 8.

If a user operation on the notification is acquired as feedback (step S65/Yes), the feedback unit 10d updates the leisure time data in step S68 in accordance with the acquired positive/negative feedback.

Feedback is repeatedly acquired and the leisure time data is repeatedly updated (steps S65 and S68) as discussed above until the present processing ends (step S71).

<3-2. Notification Control Processing according to Leisure Time>

Next, the notification control processing mentioned in step S62 will be described with reference to FIG. 8. FIG. 8 is a flowchart illustrating notification control processing according to a leisure time according to the present embodiment.

First of all, the server 1 receives a task request in step S103 as illustrated in FIG. 8. For example, messages requesting a reply (e.g. friend application and schedule check), questionnaires, and advertisements are possible as the task request in the present embodiment.

Next, in step S106, the notification control unit 10b refers to the leisure time data stored in the leisure time DB 12b to determine whether or not a target user to whom the task request is transmitted is currently spending a leisure time.

If the notification control unit 10b does not determine that the target user is spending a leisure time (S106/No), the notification control unit 10b waits in step S109 until the next leisure time comes.

Meanwhile, if the notification control unit 10b determines that the target user is spending a leisure time (S106/Yes) or if the notification control unit 10b waits in step S109 until a leisure time comes, the notification control unit 10b performs control in step S112 to issue a notification of the task request to a predetermined notification area of a requestee terminal (client 2). In this way, it is possible in the present embodiment to issue a notification of a task request during a leisure time of the target user.

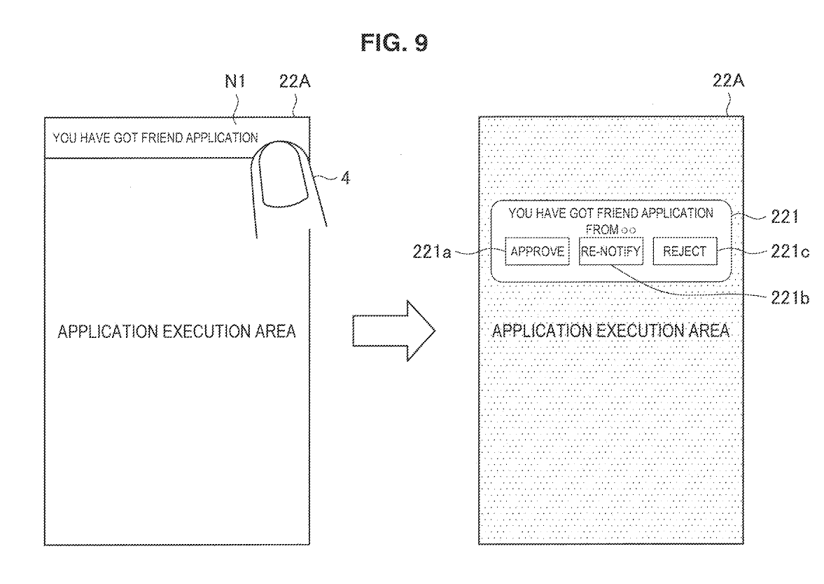

Next, if the user taps the notification area of the client 2 (step S115/Yes), the notification control unit 10b, in step S118, displays a check screen that displays the content of the notification and allows the user to select whether or not the user is able to respond to the notification. An example in which a notification and a check screen are displayed on the client 2 will be described with reference to FIGS. 9 to 12. As an example, FIGS. 9 to 12 illustrate that a notification and a check screen are displayed on a display unit 22A of the client 2A.

FIG. 9 is a diagram illustrating an example of a notification of friend application and a check screen according to the present embodiment. As illustrated in the left part of FIG. 9, a friend application notification N1 is displayed at an end of the display unit 22A of the client 2A (see the notification area S1 illustrated in FIG. 5). Friend comes into effect when users who are using a social media make application and approve each other. Users having friend registration can present information on the users to each other and exchange messages. The users are facilitated to communicate with each other via the social media.

Once a user taps the friend application notification N1 with his or her finger 4, a check screen 221 pops up on the display unit 22A as illustrated in the right part of FIG. 9. The check screen 221 displays the content of a notification such as “you have got friend application from ∘∘,” and includes an “approve” button 221a for approving the friend application, a “re-notify” button 221b for re-notifying the user during the next leisure time to allow the user to determine later whether to approve or reject the friend application, and a “reject” button 221c for rejecting the friend application. Once the user taps any of the buttons, the check screen 221 disappears and returns to the original application execution screen. Although the check screen pops up 221 in the example illustrated in FIG. 9, the present embodiment is not limited thereto. For example, the entire screen may transition to the check screen 221. Tapping any of the buttons on the check screen 221 also returns the check screen 221 to the original application execution screen in this case.

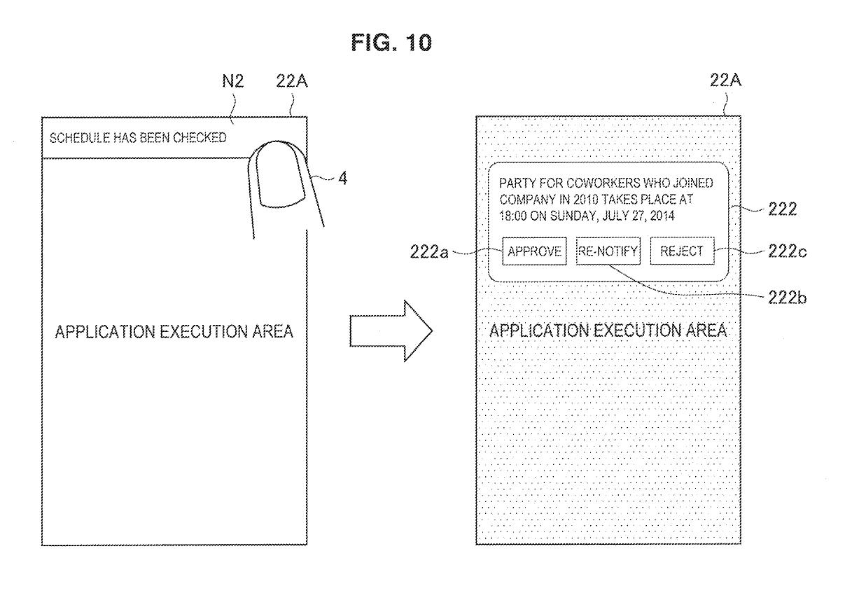

FIG. 10 is a diagram illustrating an example of a notification for schedule check and a check screen according to the present embodiment. As illustrated in the left part of FIG. 10, a schedule check notification N2 is displayed at an end of the display unit 22A of the client 2A. For example, when users who are using a social media adjust schedules, the users can register whether the users are able to participate in an event, by checking and approving the schedules.

Once a user taps the schedule check notification N2 with his or her finger 4, a check screen 222 pops up on the display unit 22A as illustrated in the right part of FIG. 10. The check screen 222 displays the content of a notification such as “a party for coworkers who joined the company in 2010 takes place at 18:00 on Sunday, Jul. 27, 2014,” and includes an “approve” button 222a for approving the schedule (attending the party), a “re-notify” button 222b for re-notifying the user during the next leisure time to allow the user to determine later whether to approve or reject the schedule check, and a “reject” button 222c for rejecting the schedule (absenting himself or herself from the party). Once the user taps any of the buttons, the check screen 222 disappears and returns to the original application execution screen.

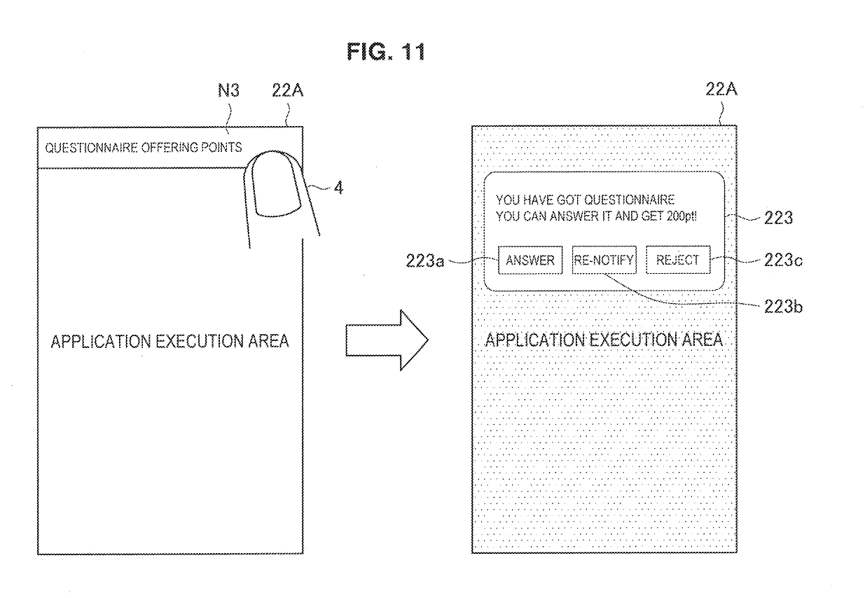

FIG. 11 is a diagram illustrating an example of a notification of a questionnaire and a check screen according to the present embodiment. As illustrated in the left part of FIG. 111, a notification N3 of a questionnaire is displayed at an end of the display unit 22A of the client 2A. For example, the questionnaire may be transmitted to users having a predetermined attribute among registered users by a service provider.

Once a user taps the notification N3 of a questionnaire with his or her finger 4, a check screen 223 pops up on the display unit 22A as illustrated in the right part of FIG. 11. The check screen 223 displays the content of a notification such as “you have got a questionnaire. You can answer it and get 200pt!,” and includes an “answer” button 223a for answering the questionnaire, a “re-notify” button 223b for re-notifying the user during the next leisure time to allow the user to determine later whether to answer or reject the questionnaire, and a “reject” button 223c for refusing to answer the questionnaire. Once the user taps the “answer” button 223a, the check screen 223 transitions to a questionnaire screen. When the user finishes answering the questionnaire, the questionnaire screen returns to the original application execution screen. Meanwhile, if the user taps the “re-notify” button 223b or the “reject” button 223c, the check screen 223 disappears and returns to the original application execution screen.

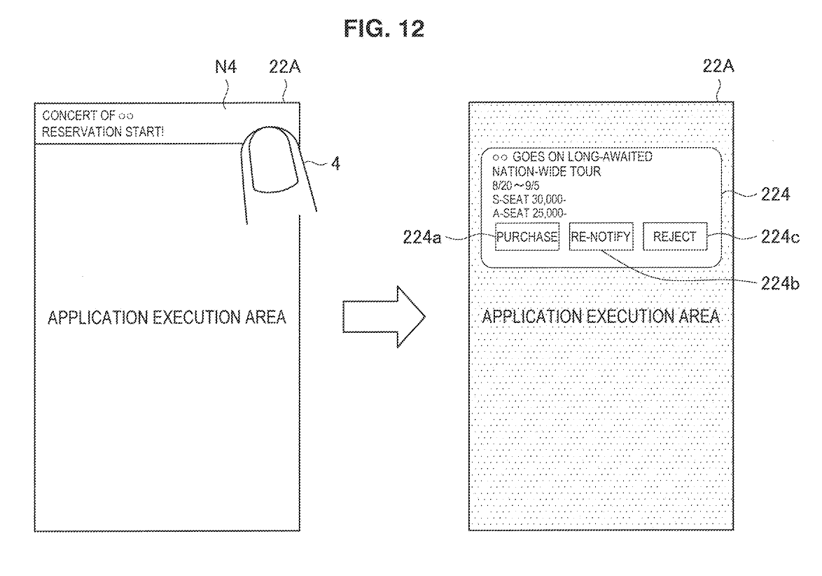

FIG. 12 is a diagram illustrating an example of a notification of an advertisement and a check screen according to the present embodiment. As illustrated in the left part of FIG. 12, an advertisement notification N4 is displayed at an end of the display unit 22A of the client 2A. For example, the advertisement may be transmitted to users having a predetermined attribute among registered users by a service provider.

Once a user taps the advertisement notification N4 with his or her finger 4, a check screen 224 pops up on the display unit 22A as illustrated in the right part of FIG. 11. The check screen 224 displays the content of an advertisement such as “00 goes on a long-awaited nation-wide tour,” and includes a “purchase” button 224a for purchasing an advertised product, a “re-notify” button 224b for re-notifying the user during the next leisure time to allow the user to determine later whether to purchase or reject the advertised product, and a “reject” button 224c for refusing to purchase the advertised product. Once the user taps the “purchase” button 224a, the check screen 224 transitions to a purchase screen. When the user finishes the purchasing procedure, the purchase screen returns to the original application execution screen. Meanwhile, if the user taps the “re-notify” button 224b or the “reject” button 224c, the check screen 224 disappears and returns to the original application execution screen.

The specific examples in which a notification and a check screen are displayed have been described so far.

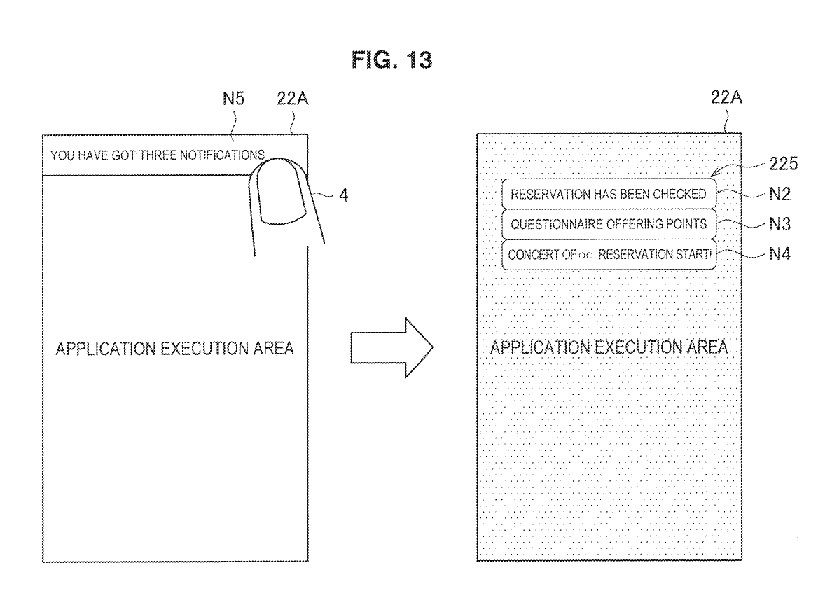

FIG. 8 is referred to again. If the “re-notify” button included in the displayed check screen is selected (S121/Yes), the feedback unit 10d of the server 1, in step S124, determines it as negative feedback because the “re-notify” button is used when the user is currently unable to substantially respond to the notification and issues an instruction to be notified again later. The feedback unit 10d then reflects the negative feedback on the leisure time data (see FIG. 6). Even if the notification area is not tapped in step S115 (step S115/No), the feedback unit 10d, in step S124, determines it as negative feedback and reflects the negative feedback on the leisure time data. After this negative feedback is reflected, the notification control 10b, in step S109, waits until the next leisure time comes. When the next leisure time comes, the notification control unit 10b performs control to notify the client 2 again of a notification of which an instruction has been issued to “re-notify” the user or a notification to which the user has not responded at all. An example in which, when notifications are accumulated, the accumulated notifications are displayed on the client 2 will be described here with reference to FIG. 13.

FIG. 13 is a diagram illustrating an example in which notifications are displayed in accordance with the present embodiment. As illustrated in the left part of FIG. 13, a notification N5 into which the notifications are grouped is displayed at an end of the display unit 22A of the client 2A. Once a user taps the notification N5 with his or her finger 4, a notification content screen 225 pops up on the display 22A as illustrated in the right part of FIG. 13. The notification content screen 225 includes notifications N2, N3 and N4. Once the user taps any of the notifications N, the corresponding check screen (see FIGS. 9 to 12) is displayed.

If the user selects a button other than the “re-notify” button included in the displayed check screen (S121/No), the feedback unit 10d, in step S127, determines it as positive feedback because the user substantially responds to the notification by approving, or answering/rejecting the notification. The feedback unit 10d then reflects the positive feedback on the leisure time data (see FIG. 6). The feedback unit 10d may learn the user's preference by regarding “approval or answer” as positive feedback and “rejection” as negative feedback.

In step S130, the control unit 10 of the server 1 performs processing of executing/deleting a task in accordance with the selection of the user. More specifically, the control unit 10 performs processing of executing a task request (such as issuing an approval notification, and displaying a questionnaire screen or an advertised product purchase screen) if the approve or answer button is selected. If the reject button is selected, the control unit 10 deletes the task request.

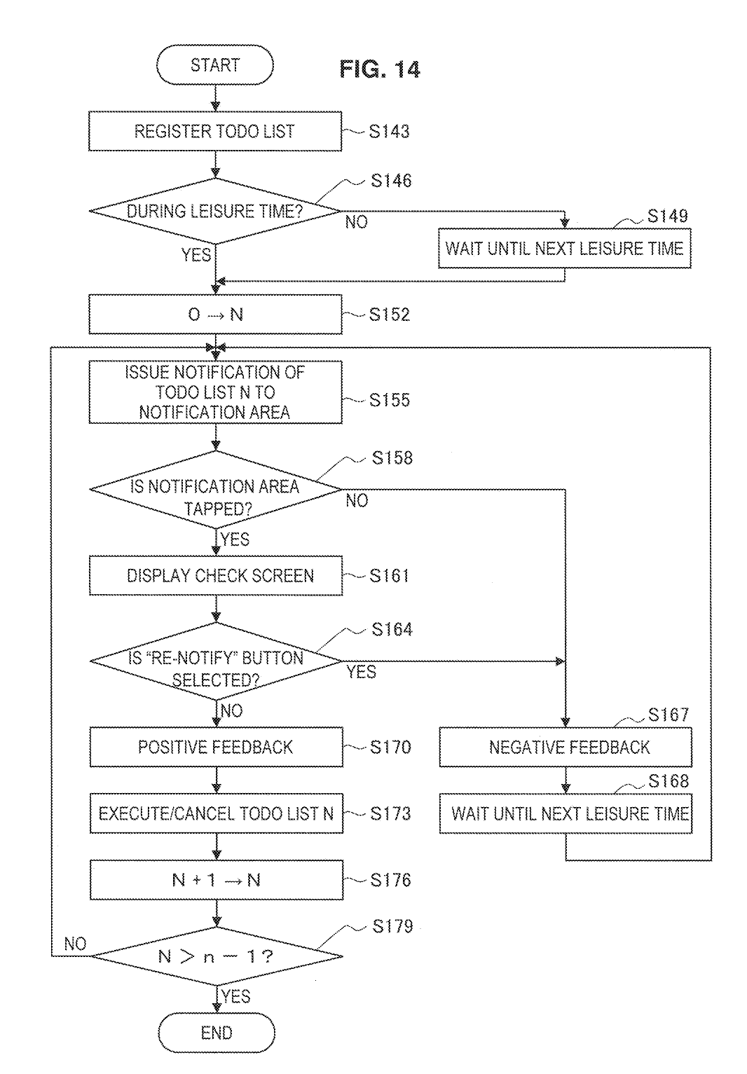

The notification control processing according to the present embodiment has been described so far. Although the above-described example is used to describe notification control processing performed when a user receives a task request for friend application, schedule check, an advertisement, a questionnaire, or the like from others, the present embodiment is not limited thereto. For example, when a user is notified of a TODO list registered by the user himself or herself, notification control can also be performed on the basis of a leisure time of the user. The specific description will be made below with reference to FIGS. 14 to 16.

### (Notification Control Processing for TODO List)

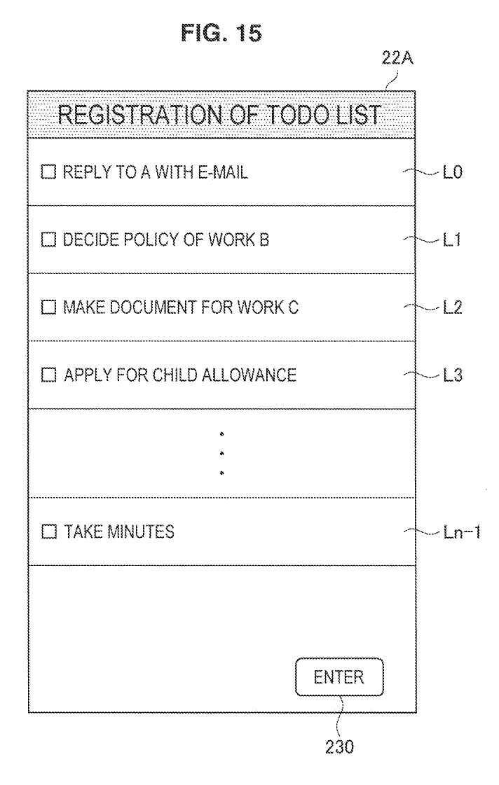

FIG. 14 is a flowchart illustrating notification control processing on a TODO list according to the present embodiment. First of all, a user registers a TODO list in step S143 as illustrated in FIG. 14. For example, a user may register a TODO list on a screen as illustrated in FIG. 15.

FIG. 15 is a diagram describing that a TODO list is registered. As illustrated in FIG. 15, for example, a user inputs, on the display unit 22A of the client 2A, a TODO list for replying to A with an e-mail (list L0), deciding the policy of work B (list L1), making a document for work C (list L2), applying for a child allowance (list L3), . . . , taking the minutes (list Ln−1), and the like. The user registers the TODO list by tapping an enter button 230.

Next, in step S146, the notification control unit 10b refers to the leisure time data stored in the leisure time DB 12b to determine whether or not a user is currently spending a leisure time.

If the notification control unit 10b does not determine that the target user is spending a leisure time (S146/No), the notification control unit 10b waits in step S149 until the next leisure time comes.

Meanwhile, the notification control unit 10b determines that the user is spending a leisure time (S146/Yes), or if the notification control unit 10b waits in step S149 until a leisure time comes, the notification control unit 10b, in step S152, inserts an initial value as “0→N”.

Next, in step S155, the notification control unit 10b performs control to issue a notification of a TODO list “N” to a predetermined notification area of a requestee terminal (client 2). In the case of “0→N”, the notification control unit 10b performs control to issue a notification of the TODO list L0 (see FIG. 15). In this way, it is possible in the present embodiment to issue a notification of a TODO list during a leisure time of the user.

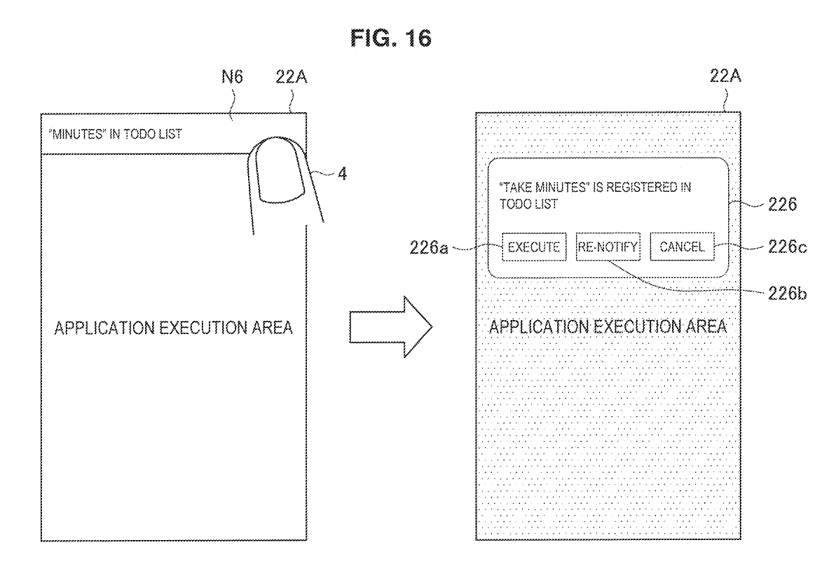

Next, if the user taps the notification area of the client 2 (step S158/Yes), the notification control unit 10b, in step S161, displays a check screen that displays the content of the notification and allows the user to select whether or not the user is able to respond to the notification. An example in which a notification and a check screen are displayed on the client 2 will be described with reference to FIG. 16. As an example, FIG. 16 illustrates that a notification and a check screen are displayed on a display unit 22A of the client 2A.

FIG. 16 is a diagram illustrating an example of a notification of a TODO list and a check screen according to the present embodiment. As illustrated in the left part of FIG. 16, a TODO list notification N6 is displayed at an end of the display unit 22A of the client 2A (see the notification area S1 illustrated in FIG. 5).

Once a user taps the TODO list notification N6 with his or her finger 4, a check screen 226 pops up on the display unit 22A as illustrated in the right part of FIG. 16. The check screen 226 displays the content of a notification such as “‘taking the minutes’ is registered in the TODO list”, and includes an “execute” button 226a for executing the TODO list, a “re-notify” button 226b for re-notifying the user during the next leisure time to allow the user to determine later whether to execute or cancel the TODO list, and a “cancel” button 226c for canceling the execution of the TODO list. Once the user taps any of the buttons, the check screen 226 disappears and returns to the original application execution screen. Although the check screen 226 pops up in the example illustrated in FIG. 16, the present embodiment is not limited thereto. For example, the entire screen may transition to the check screen 226. Tapping any of the buttons on the check screen 226 also returns the check screen 221 to the original application execution screen in this case.

The specific examples in which a notification of a TODO list and a check screen are displayed have been described so far.

FIG. 14 is referred to again. If the “re-notify” button 226b included in the displayed check screen is selected (S164/Yes), the feedback unit 10d of the server 1, in step S167, determines it as negative feedback because the “re-notify” button is used when the user is currently unable to substantially respond to the notification and issues an instruction to be notified again later. The feedback unit 10d then reflects the negative feedback on the leisure time data (see FIG. 6). Even if the notification area is not tapped in step S158 (step S158/No), the feedback unit 10d, in step S167, determines it as negative feedback and reflects the negative feedback on the leisure time data. After this negative feedback is reflected, the notification control 10b, in step S168, waits until the next leisure time comes. When the next leisure time comes, the notification control unit 10b returns to step S155 to perform control to notify the client 2 again.

If the user selects a button other than the “re-notify” button included in the displayed check screen (S164/No), the feedback unit 10d, in step S170, determines it as positive feedback because the user substantially responds to the notification by executing/canceling the notification. The feedback unit 10d then reflects the positive feedback on the leisure time data (see FIG. 6).

In step S173, the control unit 10 of the server 1 performs processing of executing/canceling the TODO list “N” in accordance with the selection of the user. More specifically, the control unit 10 performs processing of executing the TODO list “N” (such as checking the checkbox of the TODO list “N” in the list of the TODO list illustrated in FIG. 15) if the “execute” button 226a is selected. If the “cancel” button 226c is selected, the control unit 10 deletes the TODO list “N”.

In step S176, the notification control unit 10b sets “N+1→N”.

In step S179, the notification control unit 10b then determines whether or not “N>n−1” is satisfied. In the case of “No”, the notification control unit 10b returns to step S155 to issue notifications of the TODO lists L0 to Ln−1 by repeatedly issuing notifications of the TODO list “N”. Meanwhile, in the case of “Yes”, the processing of issuing a notification of the TODO list ends.

### <3-3. Status Information Presentation Processing Based on Leisure Time>

The server 1 can adequately provide information to a user by performing control to issue a notification of a task request during a leisure time of the user, accumulating a task request received while the user is not spending a leisure time, and waiting until the next leisure time in the above-described embodiment. Meanwhile, a user who has transmitted a task request (who is also referred to as requester user) does not know the status of a partner user (who is also referred to as target user). Consequently, it is not possible for the requester user to recognize when the transmitted task request is checked. The requester user is also required to transmit a task request requesting an early reply while the target user is spending a leisure time.

The server 1 then performs control to present information indicating the status of the target user based on the leisure time data to the requester user in the present embodiment. This allows the requester user to recognize whether or not the target user is able to immediately respond (whether or not the target user is spending a leisure time), before transmitting a task request. Such status information presentation processing according to the present embodiment will be described below with reference to FIG. 17. The example of FIG. 17 assumes that a user B who is a requester user uses the client 2B to transmit “friend application” as a task request.

FIG. 17 is a flowchart illustrating status information presentation processing according to the present embodiment. First of all, in step S203, the client 2B activates an application for friend application in accordance with a user operation as illustrated in FIG. 17.

Next, in step S206, the client 2B inserts an initial value as “0→N”.

In step S209, the client 2B acquires status information on a friend candidate “N” from the server 1. The server 1 extracts the leisure time data of the friend candidate “N” from the leisure data DB 12b in accordance with a request from the client 2B. If the friend candidate “N” is spending a leisure time, the server 1 replies with status information indicating that “the friend candidate “N” is able to respond”. If the friend candidate “N” is not spending a leisure time, the server 1 replies with status information indicating that “the friend candidate “N” is unable to respond”.

Next, in step S212, the client 2B displays the status (whether or not the friend candidate “N” is able to respond) of the friend candidate “N”. This allows the user B to recognize the current status of the partner user when the user B makes friend application.

In step S215, the client 2B sets “N+1→N”.

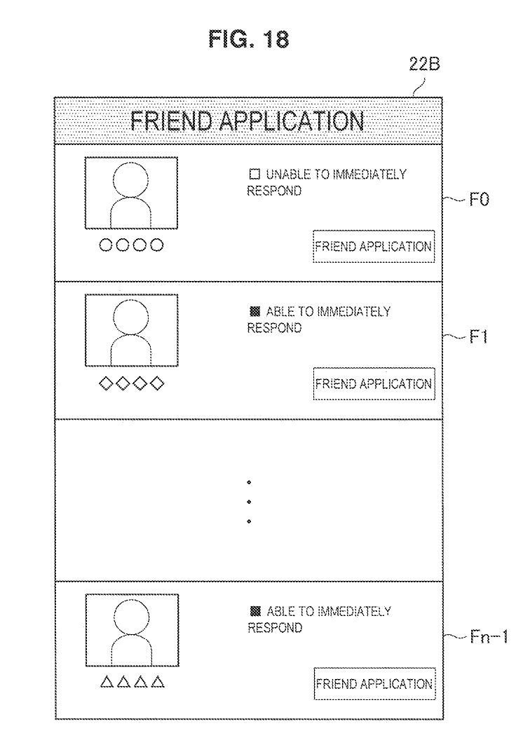

In step S218, the client 2B displays status information on friend candidates F0 to Fn−1 by repeating S209 to S215 until “N>n−1” offers “Yes”. A specific example in which status information is displayed on the client 2B will be described with reference to FIGS. 18 to 20.

FIG. 18 is a diagram illustrating an example in which status information is displayed in accordance with the present embodiment. As illustrated in FIG. 18, the display unit 22B of the client 2B displays a friend application screen, and the friend application screen displays the friend candidates F0 to Fn−1. The respective friend candidates F0 to Fn−1 are displayed with status information on the friend candidates in addition to the names, images, and friend application buttons of the friend candidates. The status information on the friend candidates indicates whether or not the respective friend candidates are currently able to respond. For example, as illustrated in FIG. 18, the status information shows “unable to immediately respond” or “able to immediately respond”. The status information may be displayed in different colors in accordance with the statuses. For example, the status information may be displayed in red if the friend candidate is unable to respond. If the friend candidate is able to respond, the status information may be displayed in blue.

This allows the user B to recognize the current status (whether or not each friend candidate is currently able to immediately respond) of each friend candidate. When the user B requests an early reply to the friend application, the user B can make friend application for the friend candidate F1 or the friend candidate Fn−1, the status information on whom shows “able to immediately respond”. Although it is not possible to expect an immediate response, it is possible to make friend application even for a friend candidate for whom it is indicated that the friend candidate is unable to immediately respond.

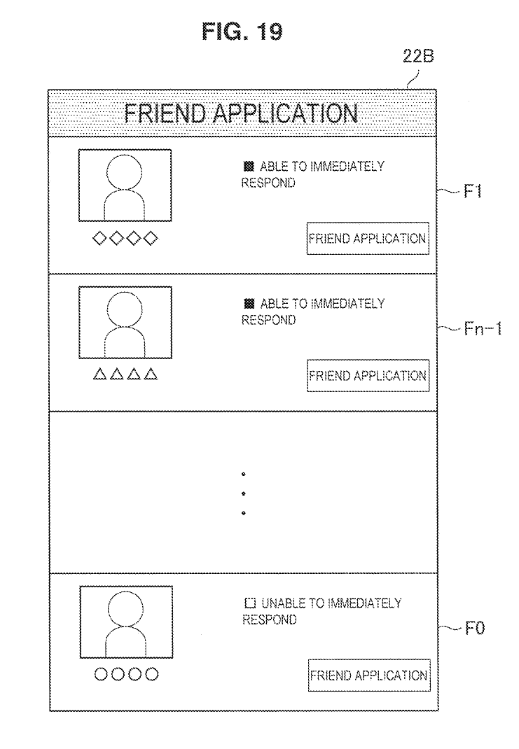

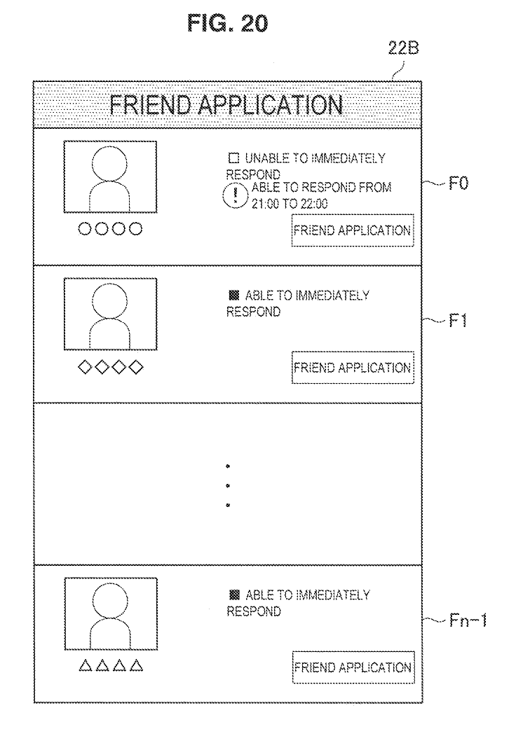

An example in which status information is displayed is not limited to the example illustrated in FIG. 18. For example, status information may be displayed by display methods as illustrated in FIGS. 19 and 20.

FIG. 19 is a diagram illustrating another example in which status information is displayed in accordance with the present embodiment. The friend candidates F1, Fn−1, . . . who are able to immediately respond are displayed in the upper part of a friend application screen in the example illustrated in FIG. 19, while a friend candidate F0 who is unable to immediately respond is displayed in the lower part. Preferentially displaying the friend candidate F who is able to immediately respond in this way allows the user B to search, in less time, for a friend candidate who is able to immediately respond, by scrolling the friend application screen.

FIG. 20 is a diagram illustrating another example in which status information is displayed in accordance with the present embodiment. Information showing “unable to immediately respond” for the friend candidate F0, who is displayed on a friend application screen and is unable to immediately respond, to indicate whether or not the friend candidate F0 is currently able to respond, and information showing “able to respond from 21:00 to 22:00” to indicate the nearest leisure time (time slot during which the friend candidate F0 is able to immediately respond) are displayed in the example illustrated in FIG. 20. Not only information indicating whether or not a friend candidate is currently able to respond, but also information indicating the nearest time slot (i.e. next coming time slot) during which the friend candidate is able to respond may also be displayed in this way as status information.

Next, FIG. 17 will be referred to again. If the user B selects the application button of the friend “N” in step S221, the client 2B, in step S224, transmits a friend “N” application request to the server 1. The server 1 may notify a target user at the time when the server1 receives the friend application from the client 2B. Alternatively, if the target user is spending a leisure time, the server 1 may notify the target user. If the target user is not spending a leisure time, the server 1 may accumulate the friend application and notify the target user when a leisure time comes.

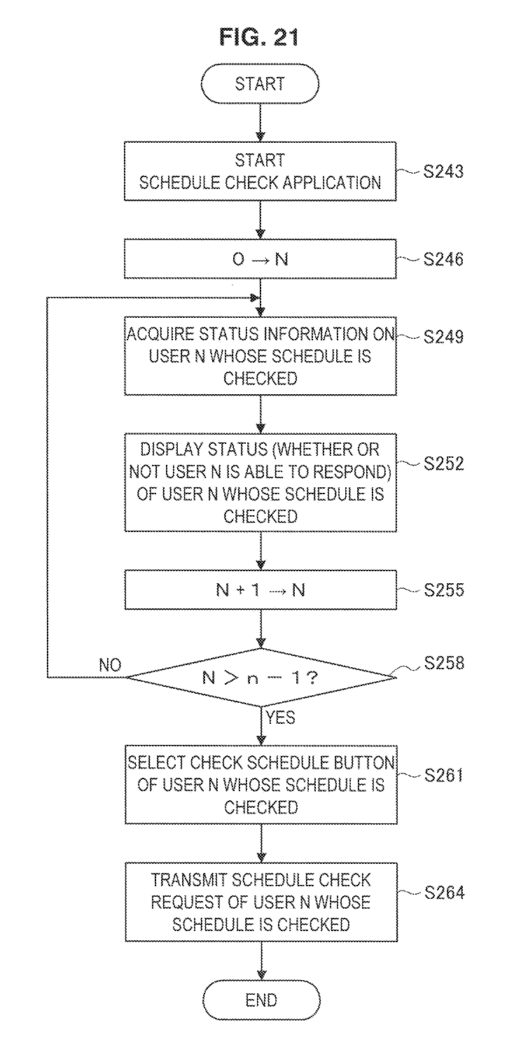

The status presentation control processing according to the present embodiment has been described so far. Although friend application is used as a task request in FIG. 17, a task request is not limited to friend application. For example, a schedule may be checked as a task request. The following describes, with reference to FIG. 21, status information presentation processing performed for a target user (user whose schedule is checked) if a task request is to check a schedule.

### (Status Information Presentation Processing for Checking Schedule)

FIG. 21 is a flowchart illustrating status information presentation processing according to the present embodiment. First of all, in step S243, the client 2B activates a schedule check application in accordance with a user operation as illustrated in FIG. 21.

Next, in step S246, the client 2B inserts an initial value as “0 N”.

In step S249, the client 2B acquires status information on a user “N” whose schedule is checked from the server 1. The server 1 extracts the leisure time data of the user “N” whose schedule is checked from the leisure data DB 12b in accordance with a request from the client 2B. If the friend candidate “N” is spending a leisure time, the server 1 replies with status information indicating that “the friend candidate “N” is able to respond”. If the friend candidate “N” is not spending a leisure time, the server 1 replies with status information indicating that “the friend candidate “N” is unable to respond”.

Next, in step S252, the client 2B displays the status (whether or not the user “N” whose schedule is checked is able to respond) of the user “N” whose schedule is checked. This allows the user B to recognize the current status of the partner user when the user B makes a schedule check request.

In step S255, the client 2B sets “N+1 N”.

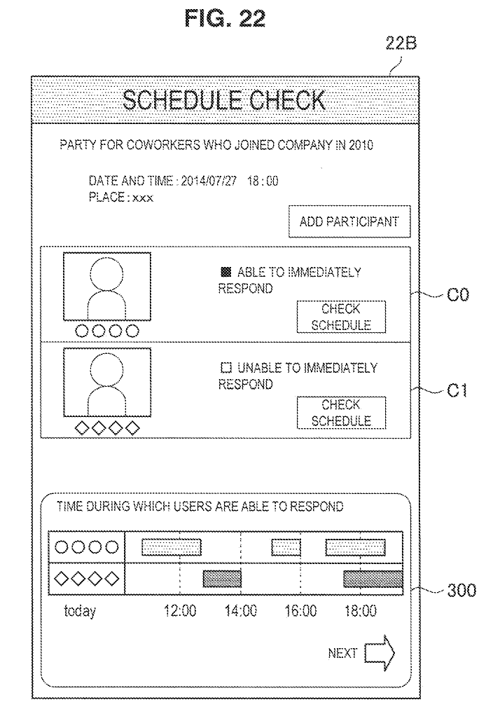

In step S258, the client 2B displays status information on users C0 to Cn−1 whose schedules are checked, by repeating S249 to S255 until “N>n−1” offers “Yes”. A specific example in which status information is displayed on the client 2B will be described with reference to FIG. 22.

FIG. 22 is a diagram illustrating an example in which status information is displayed in accordance with the present embodiment. As illustrated in FIG. 22, the display unit 22B of the client 2B displays a schedule check screen, and the schedule check screen displays the content of a schedule, users C0 and C1 whose schedules are checked, and a comparison 300 of times during which the users are able to respond.

As illustrated in FIG. 22, for example, the user B sets “party for coworkers who joined the company in 2010, date and time: 18:00 on Jul. 27, 2014, and place: xxx” as the content of the schedule. An add participant button is tapped when a user who is going to participate in the schedule (user whose schedule is checked) is added. The user B can select a participant user to add from a friend list screen by tapping the add participant button.

The respective users C0 and C1 whose schedules are checked are displayed with status information on the users whose schedules are checked in addition to the names, images, and check schedule buttons of the users. For example, the status information on the users whose schedules are checked shows “unable to immediately respond” or “able to immediately respond” as illustrated in FIG. 22. The status information may be displayed in different colors. The status information may be displayed in red if the user is unable to respond. If the user is able to respond, the status information may be displayed in blue.

This allows the user B to recognize the current status (whether or not each user whose schedule is checked is able to immediately respond) of each user whose schedule is checked. When the user B requests an early reply to the schedule check request, the user B can make a check request to the user C0 whose schedule is checked, the status information on whom shows “able to immediately respond”. Although it is not possible to expect an immediate response, it is possible to make a check request even to a user whose schedule is checked, for whom it is indicated that the friend candidate is unable to immediately respond.

When users adjust schedules, it is more efficient to concurrently check the schedules of all the users. It is then required to make schedule check requests when all the users whose schedules are checked are able to immediately respond. For example, presenting the comparison 300 of times during which the users are able to respond as a kind of status information as illustrated in FIG. 22 thus allows the user B to recognize a time slot during which all the users are able to immediately respond. If schedule check requests are sent to all the users around 18:00 in the example illustrated in FIG. 22, the schedules can be efficiently adjusted.

Next, FIG. 21 will be referred to again. If the user B selects the check schedule button of the user “N” whose schedule is checked in step S261, the client 2B, in step S264, transmits a schedule check request of the user “N” whose schedule is checked to the server 1. The server 1 may notify a target user at the time when the server1 receives the schedule check request. Alternatively, if the target user is spending a leisure time, the server 1 may notify the target user. If the target user is not spending a leisure time, the server 1 may accumulate the friend application and notify the target user when a leisure time comes.

### 4. CONCLUSION

As discussed above, the information processing system according to an embodiment of the present disclosure makes it possible to estimate a leisure time of a user and to provide information to the user at right timing.

The preferred embodiment(s) of the present disclosure has/have been described above with reference to the accompanying drawings, whilst the present disclosure is not limited to the above examples. A person skilled in the art may find various alterations and modifications within the scope of the appended claims, and it should be understood that they will naturally come under the technical scope of the present disclosure.

It is also possible to make a computer program for causing hardware such as the CPU, ROM, and RAM built in the server 1 and the client 2 to implement the functions of the server 1 and the client 2. There is also provided a computer-readable storage medium having the computer program stored therein.

The advantageous effects described herein are merely explanatory or illustrative, but not limited. That is to say, the technology according to the present disclosure may attain other advantageous effects obvious to those skilled in the art from the present specification in combination with the above-described advantageous effects or instead thereof.

Additionally, the present technology may also be configured as below.

(1)

An information processing device including:

an estimation unit configured to extract an information input cycle within a predetermined period on the basis of a history of an information input operation performed by a user on an Internet, and to estimate a leisure time of the user; and

a notification control unit configured to perform control to issue a predetermined notification during the estimated leisure time.

(2)

The information processing device according to (1),

wherein the notification control unit performs control to accumulate a notification to the user received while the user is not spending a leisure time, and to notify the user of the accumulated notification to the user when a leisure time comes.

(3)

The information processing device according to (1) or (2),

wherein the estimation unit estimates, as a leisure time, a time during which the user is performing the information input operation on a social media or an e-mail, on the basis of the history of the information input operation.

(4)

The information processing device according to (3),

wherein the estimation unit estimates a leisure time in accordance with a result obtained by analyzing content of information input into the social media or the e-mail.

(5)

The information processing device according to any one of (1) to (4),

wherein the notification control unit performs control to display a notification on a predetermined notification area of a display screen of a user terminal.

(6)

The information processing device according to (5),

wherein, when the user selects the notification displayed on the notification area, the notification control unit performs control to display a check screen that displays content of the notification and allows the user to select whether or not the user is able to respond to the notification.

(7)

The information processing device according to any one of (1) to (6), further including:

a status presentation unit configured to present, to a requester user, status information indicating whether or not a target user is spending a leisure time slot.

(8)

The information processing device according to (7),

wherein the status presentation unit performs control to display, on a display screen of a terminal of the requester user, whether or not one or more target users are each currently spending leisure times, on the basis of the status information.

(9)

The information processing device according to (7),

wherein the status presentation unit performs control to preferentially display a user of one or more target users who is currently spending a leisure time on a display screen of a terminal of the requester user on the basis of the status information.

(10)

The information processing device according to (7),

wherein the status presentation unit performs control to display a comparison between leisure time slots of one or more target users on a display screen of a terminal of the requester user on the basis of the status information.

The information processing device according to (7),

wherein the status presentation unit performs control to display a next coming leisure time on a display screen of a terminal of the requester user on the basis of the status information when the target user is not currently spending a leisure time.

(12)

The information processing device according to any one of (1) to (11), further including:

a feedback unit configured to adjust the leisure time estimated by the estimation unit, on the basis of whether or not the user has substantially responded to the notification.

(13)

An control method including:

extracting an information input cycle within a predetermined period on the basis of a history of an information input operation performed by a user on an Internet, and estimating a leisure time of the user; and

performing control to issue a predetermined notification during the estimated leisure time.

(14)

A program for causing a computer to function as:

an estimation unit configured to extract an information input cycle within a predetermined period on the basis of a history of an information input operation performed by a user on an Internet, and to estimate a leisure time of the user; and

a notification control unit configured to perform control to issue a predetermined notification during the estimated leisure time.

### REFERENCE SIGNS LIST

1 server
10 control unit
10a estimation unit
10b notification control unit
10c status presentation unit
10d feedback unit
11 communication unit
12 storage unit
12a operation history DB
12b leisure time DB
3 social media

1. An information processing device comprising:
an estimation unit configured to extract an information input cycle within a predetermined period on the basis of a history of an information input operation performed by a user on an Internet, and to estimate a leisure time of the user; and
a notification control unit configured to perform control to issue a predetermined notification during the estimated leisure time.

2. The information processing device according to claim 1,
wherein the notification control unit performs control to accumulate a notification to the user received while the user is not spending a leisure time, and to notify the user of the accumulated notification to the user when a leisure time comes.

3. The information processing device according to claim 1,
wherein the estimation unit estimates, as a leisure time, a time during which the user is performing the information input operation on a social media or an e-mail, on the basis of the history of the information input operation.

4. The information processing device according to claim 3,
wherein the estimation unit estimates a leisure time in accordance with a result obtained by analyzing content of information input into the social media or the e-mail.

5. The information processing device according to claim 1,
wherein the notification control unit performs control to display a notification on a predetermined notification area of a display screen of a user terminal.

6. The information processing device according to claim 5,
wherein, when the user selects the notification displayed on the notification area, the notification control unit performs control to display a check screen that displays content of the notification and allows the user to select whether or not the user is able to respond to the notification.

7. The information processing device according to claim 1, further comprising:
a status presentation unit configured to present, to a requester user, status information indicating whether or not a target user is spending a leisure time slot.

8. The information processing device according to claim 7,
wherein the status presentation unit performs control to display, on a display screen of a terminal of the requester user, whether or not one or more target users are each currently spending leisure times, on the basis of the status information.

9. The information processing device according to claim 7,
wherein the status presentation unit performs control to preferentially display a user of one or more target users who is currently spending a leisure time on a display screen of a terminal of the requester user on the basis of the status information.

10. The information processing device according to claim 7,
wherein the status presentation unit performs control to display a comparison between leisure time slots of one or more target users on a display screen of a terminal of the requester user on the basis of the status information.

11. The information processing device according to claim 7,
wherein the status presentation unit performs control to display a next coming leisure time on a display screen of a terminal of the requester user on the basis of the status information when the target user is not currently spending a leisure time.

12. The information processing device according to claim 1, further comprising:
a feedback unit configured to adjust the leisure time estimated by the estimation unit, on the basis of whether or not the user has substantially responded to the notification.

13. An control method comprising:
extracting an information input cycle within a predetermined period on the basis of a history of an information input operation performed by a user on an Internet, and estimating a leisure time of the user; and
performing control to issue a predetermined notification during the estimated leisure time.

14. A program for causing a computer to function as:
an estimation unit configured to extract an information input cycle within a predetermined period on the basis of a history of an information input operation performed by a user on an Internet, and to estimate a leisure time of the user; and
a notification control unit configured to perform control to issue a predetermined notification during the estimated leisure time.
